(19) United States
(12) Patent Application Publication
(10) Pub. No.: US 2018/0166662 A1
(43) Pub. Date: Jun. 14, 2018

(54) ENERGY STORAGE APPARATUS

(71) Applicant: City University of Hong Kong, Kowloon (HK)

(72) Inventors: Chunyi Zhi, Shatin (HK); Hongfei Li, Tai Po (HK)

(21) Appl. No.: 15/377,035

(22) Filed: Dec. 13, 2016

(51) Int. Cl. H01M 2/02; H01M 4/04; H01M 4/50; H01M 10/054; H01M 10/0565; H01G 11/36; H01G 11/46; H01G 11/62; H01G 11/64; H01G 11/52; H01G 11/06; H01G 11/26; H01G 11/86; H01G 11/78

(52) U.S. Cl. CPC H01M 2/0275; H01M 2300/0082; H01M 4/502; H01M 4/0409; H01M 10/054; H01M 10/0565; H01G 11/36; H01G 11/46; H01G 11/62; H01G 11/64; H01G 11/52; H01G 11/06; H01G 11/26; H01G 11/86; H01G 11/78; H01M 2300/0085; H01M 4/0452

(57) ABSTRACT

An energy storage apparatus and a method for fabricating the energy storage apparatus. The energy storage apparatus includes a pair of electrodes including an anode and a cathode; an electrolyte at least partially surrounding each of the pair of electrodes; and an encapsulation arranged to encapsulate the electrodes and the electrolyte; wherein the combination of the electrodes, the electrolyte and the encapsulation is mechanically flexible.

### TECHNICAL FIELD

The present invention relates to an energy storage apparatus and a method for fabricating the energy storage apparatus, although not exclusively, to a flexible rechargeable battery.

### BACKGROUND

Electronic or electrical devices usually operate with suitable energy sources connected thereto. Common energy sources may include electrical sockets in a power grid, photovoltaic cells, fuel cells and batteries.

Portable electric devices, especially wearable devices are usually powered by portable energy sources such as batteries. Batteries are usually manufactured with a rigid shell to isolate the chemical materials from the surrounding environment. However, some batteries may include corrosive electrolytes in liquid or aqueous state, and may damage the electric devices or cause injury to users if the electrolyte leaks through the encapsulation when the batteries operate.

### SUMMARY OF THE INVENTION

In accordance with a first aspect of the present invention, there is provided an energy storage apparatus comprising a pair of electrodes including an anode and a cathode; an electrolyte at least partially surrounding or adjacent to each of the pair of electrodes; and an encapsulation arranged to encapsulate the electrodes and the electrolyte; wherein the combination of the electrodes, the electrolyte and the encapsulation is mechanically flexible.

In an embodiment of the first aspect, the electrodes, the electrolyte and the encapsulation are in a solid state.

In an embodiment of the first aspect, each the anode and/or the cathode comprises a flexible carrier arranged to retain an energy storage material thereon.

In an embodiment of the first aspect, the flexible carrier includes an electrical conductor.

In an embodiment of the first aspect, the flexible carrier includes a shape of a fiber or a film.

In an embodiment of the first aspect, the flexible carrier includes one or more carbon nanotubes.

In an embodiment of the first aspect, the energy storage material is retained on a surface of the flexible carrier.

In an embodiment of the first aspect, the flexible carrier forms at least a part of the encapsulation.

In an embodiment of the first aspect, the energy storage material includes an anode material and a cathode material in the anode and the cathode respectively.

In an embodiment of the first aspect, the anode material includes at least one of zinc, zinc alloy, a zinc composite and an electrical conductive additive.

In an embodiment of the first aspect, the cathode material includes manganese oxide.

In an embodiment of the first aspect, the electrolyte is gelatine-based.

In an embodiment of the first aspect, the electrolyte is polymer-based.

In an embodiment of the first aspect, the electrolyte comprises a metal salt and at least one of a polymer or a polymer composite.

In an embodiment of the first aspect, the electrolyte includes a hierarchical polymer structure.

In an embodiment of the first aspect, the electrolyte includes a gelatin material.

In an embodiment of the first aspect, the gelatin material is grafted with polyacrylamide.

In an embodiment of the first aspect, the gelatine material and/or the polyacrylamide are arranged to increase an electrical conductivity of the electrolyte.

In an embodiment of the first aspect, the gelatine material and/or the polyacrylamide are arranged to increase a hydrophilicity and therefore an ionic conductivity of the electrolyte.

In an embodiment of the first aspect, the gelatin material is filled in a polyacrylonitrile fiber membrane.

In an embodiment of the first aspect, the electrolyte is arranged to physically separate the anode from the cathode.

In an embodiment of the first aspect, the electrolyte is arrange to facilitate ion transportations between the anode and the cathode.

In an embodiment of the first aspect, the electrolyte includes a plurality of carboxyl group structures arranged to facilitate ion transportations between the anode and the cathode.

In an embodiment of the first aspect, the energy storage apparatus is rechargeable.

In an embodiment of the first aspect, the cathode is arranged to reversibly store and release anion provided by the anode during a charging process and a discharging process respectively.

In an embodiment of the first aspect, the combination of the electrodes, the electrolyte and the encapsulation defines a fabric yarn.

In an embodiment of the first aspect, the energy storage apparatus is operable to charge and/or discharge when the fabric yarn is bent, knotted, twisted or maintained substantially straight.

In an embodiment of the first aspect, the energy storage apparatus comprises a plurality of the fabric yarn combined to define a plane of fabric.

In accordance with a second aspect of the present invention, there is provided a method for fabricating an energy storage apparatus in accordance with the first aspect, comprising the steps of: depositing an anode material on a first flexible carrier to define the anode; depositing a cathode material on a second flexible carrier to define the cathode; filling the encapsulation with the anode, the cathode and the electrolyte; and sealing the encapsulation.

In an embodiment of the second aspect, the anode material is electroplated on a surface of the first flexible carrier.

In an embodiment of the second aspect, a layer of zinc is electroplated onto the first flexible carrier in an aqueous solution of Zn(CH₃COO)₂.

In an embodiment of the second aspect, the cathode material is coated on a surface of the second flexible carrier.

In an embodiment of the second aspect, a layer of manganese oxide is formed on the surface of the second flexible carrier by coating manganese oxide slurry on the second flexible carrier.

In an embodiment of the second aspect, the cathode material is dip-coated or blade-coated on the surface of the second flexible carrier.

In an embodiment of the second aspect, the method further comprises the steps of: filling the encapsulation with the anode, the cathode and the electrolyte; and sealing the encapsulation.

In an embodiment of the second aspect, the method further comprises the step of combining the anode, the electrolyte and the cathode to form a multi-layer stack, wherein the first flexible carrier and the second flexible carrier form at least a part of the encapsulation.

In accordance with a third aspect of the present invention, there is provided an energy storage apparatus comprising a pair of electrodes including an anode and a cathode; and an electrolyte sandwiched between the pair of electrodes; wherein the electrolyte the electrolyte includes a hierarchical polymer structure.

In an embodiment of the third aspect, the electrodes and the electrolyte are in a solid state.

In an embodiment of the third aspect, the electrodes and the electrolyte are mechanically flexible.

In an embodiment of the third aspect, the electrolyte includes a gelatin material.

In an embodiment of the third aspect, the gelatin material is grafted with polyacrylamide.

In an embodiment of the third aspect, the gelatin material is filled in a polyacrylonitrile fiber membrane.

### BRIEF DESCRIPTION OF THE DRAWINGS

Embodiments of the present invention will now be described, by way of example, with reference to the accompanying drawings in which:

FIG. 1 is a perspective view of an energy storage apparatus in accordance with one embodiment of the present invention;

FIG. 2 is a process flow diagram showing a method for fabricating an energy storage apparatus of FIG. 1;

FIGS. 3A to 3B are microscopic images of the initial carbon nanotube fibers in the energy storage apparatus of FIG. 1;

FIGS. 3C to 3D are microscopic images of the CNT-Zn yarn in the energy storage apparatus of FIG. 1;

FIGS. 3E to 3F are microscopic images of the CNT-MnO₂ yarn in the energy storage apparatus of FIG. 1;

FIGS. 3G is an SEM image of the MnO₂ material for producing the CNT-MnO₂ yarn in FIG. 3E;

FIGS. 3H is a TEM image of the MnO₂ material for producing the CNT-MnO₂ yarn in FIG. 3E;

FIG. 4A is a photographic image of a free-standing gelatine/polymer-based electrolyte (GPE) for use in the energy storage apparatus of FIG. 1;

FIG. 4B is a photographic image of a GPE of FIG. 4B being folded;

FIG. 4C is an SEM image of the GPE of FIG. 4A;

FIG. 4D is a plot showing an AC impedance spectra of the GPE of FIG. 4A in the frequency range from 10 kHz to 0.01 Hz;

FIGS. 5A to 5D are plots showing electrochemical performances of the energy storage apparatus of FIG. 1;

FIGS. 6A to 6C are plots showing electrochemical performance of energy storage apparatus of FIG. 1 under different deformation statuses;

FIGS. 7A to 8C illustrate different operations of the energy storage apparatus of FIG. 1 under different deformation status, when connecting to a digital clock or a pulse sensor;

FIG. 9 is a perspective view of an energy storage apparatus in accordance with one embodiment of the present invention;

FIG. 10 is an example process flow of fabricating an electrolyte in the energy storage apparatus of FIG. 9;

FIGS. 11A to 11B are images of the as-fabricated electrolyte film for use in fabricating the energy storage apparatus of FIG. 9;

FIG. 11C is an SEM image of a PAN electrospun fiber membrane used for the fabrication of the electrolyte of FIG. 10;

FIGS. 11D to 11E are SEM images of the as-fabricated electrolyte film of FIG. 11A;

FIG. 11F is a plot showing FTIR spectra of GE and HPE for use as electrolyte in the energy storage apparatus of FIG. 9;

FIG. 11G is a plot showing X-ray diffraction patterns of GE and HPE for use as electrolyte in the energy storage apparatus of FIG. 9;

FIG. 11H is a plot showing AC impedance spectra of the GE and HPE for use as electrolyte in the energy storage apparatus of FIG. 9 in the frequency range from 10 kHz to 0.01 Hz;

FIG. 12 is a plot showing XRD pattern of MnO₂/CNT composites for use as cathode material in the energy storage apparatus of FIG. 9;

FIG. 13A is an image of an as-fabricated energy storage apparatus of FIG. 9 being bent;

FIGS. 13B and 13C are TEM images of MnO₂/CNT composites for use as cathode material in the energy storage apparatus of FIG. 9, the inset shows lattice fringes along the (110) planes;

FIG. 13D is an SEM image of the zinc anode in the energy storage apparatus of FIG. 9;

FIGS. 14A to 14E are plots showing electrochemical performances of the energy storage apparatus of FIG. 9;

FIGS. 15A to 15D are plots showing electrochemical performances of the energy storage apparatus of FIG. 9 under different extreme conditions; and

FIG. 16 is an illustration of an example operation of the energy storage apparatus of FIG. 9.

### DETAILED DESCRIPTION OF THE PREFERRED EMBODIMENT

The inventors have, through their own research, trials and experiments, devised that flexible or wearable electronics may be implemented in sportswear, military uniforms, and implantable medical devices. These devices may require high performance and highly reliable power sources with excellent flexibility and safety.

Flexible energy-storage devices, including primary Zn—MnO₂ batteries, lithium ion batteries, and supercapacitors may be used as power sources for these devices. Among these examples, fiber or yarn-based energy devices may be advantageous owing to their tiny volume, superior flexibility and outstanding electrochemical performance. Preferably, these energy storage devices should be capable of delivering high energy capacity under severe conditions, for example, being bent, pressed, or even cut, such that these devices serve as reliable power sources in different cases.

With advantages such as low cost, eco-friendliness, good specific capacity and ease of fabrication, the Zn/MnO₂ batteries may be sued as one of the most popular primary cells. In one example embodiment, a flexible fiber-type Zn/MnO₂ battery may include carbon fiber as current collector. In another example embodiment, flexible alkaline batteries may be produced based on polymer gel electrolyte. However, some these flexible Zn/MnO₂ cells are primary batteries and are not rechargeable.

In an alternative embodiment, a Zn-MnO₂ battery (ZMB) may comprise a manganese oxide cathode, a zinc metal anode and an environment-friendly mild aqueous electrolyte. Since the ZMB may be rechargeable, and the ZMB may be provided with high energy density, excellent reversibility, low cost and high safety, it may be used as an attractive alternative to lithium ion batteries. The ZMB battery is also able to deliver a high energy density and good reversibility.

The inventor devises that zinc ion conducting polymer electrolytes is an important component in solid-state rechargeable Zn/MnO₂ batteries. In some examples, zinc triflate (Zn(CF₃SO₃)₂) in combination with polymer hosts including polyethylene oxide (PEO) and poly(vinilydenefluoride-co-hexafluoropropylene) (PVDF-HFP) may be used. However, these polymer electrolytes suffer from relatively low ionic conductivities, rapid degradation and low solubility of ZnSO₄ and MnSO₄ that are the mostly used electrolyte salts in reversible ZIBs.

Alternatively, natural polymers may be employed as solid or gel electrolytes for solid-state devices. For example, gelatin may be used due to its high ionic conductivity, environmental friendliness, high solubility of inorganic salts and abundance in nature.

Preferably, some rechargeable Zn—MnO₂ batteries may be in all-solid state with high flexibility, wearability, and excellent electrochemical performance, and may be used as a reliable power source for various flexible or wearable electronics.

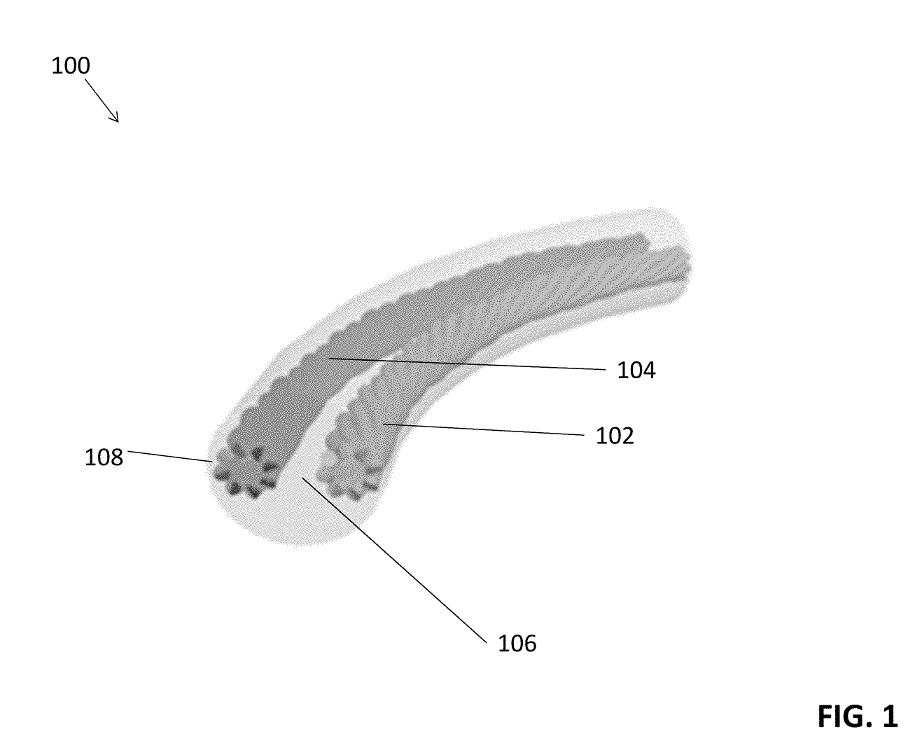

With reference to FIG. 1, there is shown an embodiment of an energy storage apparatus 100 comprising a pair of electrodes including an anode 102 and a cathode 104; an electrolyte 106 at least partially surrounding each of the pair of electrodes 102, 104; and an encapsulation 108 arranged to encapsulate the electrodes and the electrolyte 106; wherein the combination of the electrodes 102, 104, the electrolyte 106 and the encapsulation 108 is mechanically flexible.

In this embodiment, the energy storage apparatus 100 may operate as a battery device. The energy storage apparatus 100 is arranged to store a predetermined amount of chemical energy which may be converted to electrical energy during operation. For example, reduction and oxidation reactions may occur within the battery device 100 such that electrical energy is produced and the electrical energy may be used to drive electrical/electronic devices connected thereto.

Preferably, the electrodes 102, 104, the electrolyte 106 and the encapsulation 108 are all in a solid state such that the robustness of the battery device 100 may be maximized. In other words, common defects or malfunctions of a battery device 100 such as electrolyte 106 leakage may be eliminated. In addition, these solid components are preferably mechanical flexible, such that the energy storage apparatus 100 is mechanically flexible. The flexibility of the battery device 100 may allow the battery device 100 to be bent or folded to some extends when being engaged to an object, for example when the battery device 100 is a part of a wearable electronic apparatus, one or more portions of the battery device 100 may be bent according to the shape of the engaging surface. More preferably, the battery device 100 may operate when it is bent, knotted, twisted or maintained substantially straight.

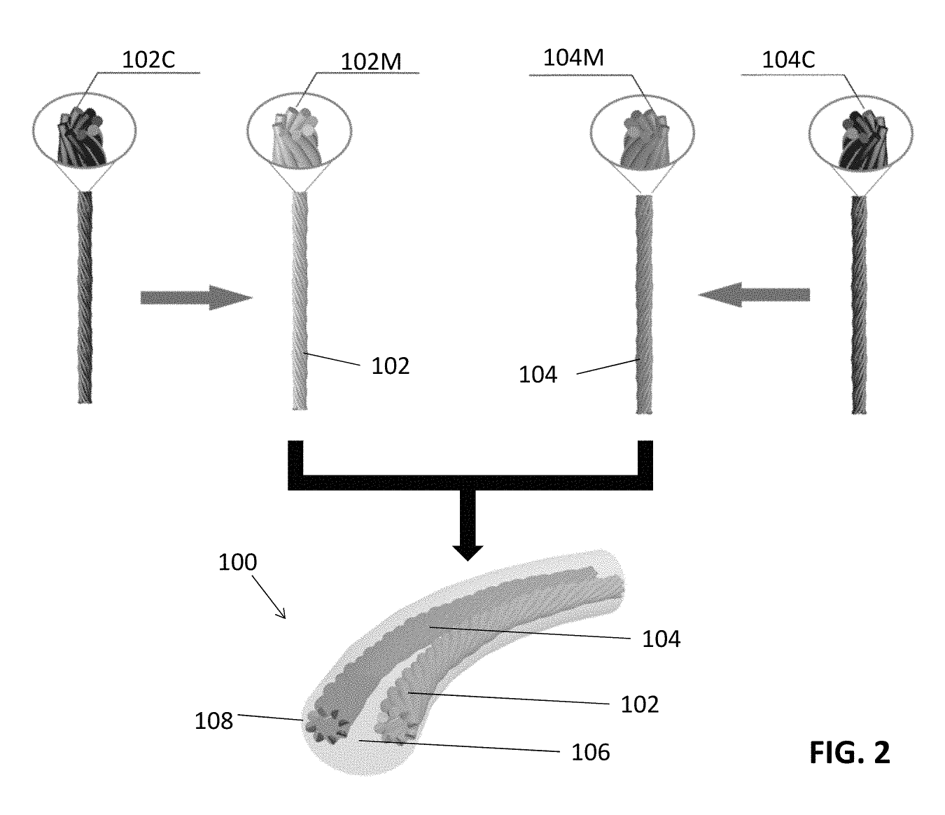

With reference also to FIG. 2, there is shown the internal structure of the energy storage apparatus 100 in accordance with an embodiment of the present invention. Each of the electrodes (i.e. the anode 102 and the cathode 104), comprise a flexible carrier arranged to retain an energy storage material thereon. Preferably, the flexible carrier includes an electrical conductor such that electrons or electrical energy may be transmitted along the flexible carrier.

The flexible carrier may be provided with a shape of a fiber or a string. Energy storage materials may be coated on the surface of the flexible carrier, in which the energy storage materials contribute the chemical reactions which store or release electrical energy during operation. Preferably, the energy storage material includes an anode material 102M and a cathode material 104M in the anode 102 and the cathode 104 respectively.

The energy storage apparatus 100 may be preferably rechargeable. In a rechargeable battery 100, the cathode 104 is arranged to reversibly store and release anion provided by the anode 102 (or the electrolyte 106) during a charging process and a discharging process respectively. For example, the energy storage apparatus 100 may be a Zn—MnO₂ battery such that the manganese oxide cathode 104 may reversibly store and release zinc ion provided by the anode 102 or the electrolyte 106 during the charge and discharge operations. In some alternative embodiments, the energy storage apparatus 100 is designed to operate with a single discharge cycle and is not rechargeable.

Preferably, the anode material 102M includes zinc, zinc alloy and/or a zinc composite, such that the anode 102 electrode may reversibly store and release zinc ion during operation. Alternatively, other suitable metal, alloy and/or composite material may be included in the anode electrode 102. On the other hand, the the cathode material 104M includes manganese oxide or any suitable material which may trap and/or release an anion during the charge and discharge operations.

Referring to FIG. 2, there is shown an example embodiment of a method for fabricating an energy storage apparatus 100, comprising the steps of: depositing an anode material 102M on a first flexible carrier 102C to define the anode 102; depositing a cathode material 104M on a second flexible carrier 104C to define the cathode 104; filling the encapsulation 108 with the anode 102, the cathode 104 and the electrolyte 106; and sealing the encapsulation 108.

The electrode materials or the energy storage materials may be preferably coated or deposited on the surface of the flexible carrier 102C, 104C. For example, two carbon nanotube fiber may be provided as the flexible carriers. The anode electrode 102 may be fabricated by depositing anode material 102M such as zinc on the surface of the carbon nanotube fiber 102C using electroplating or electrodeposition method. The cathode electrode 104 may be fabricated by dip-coating MnO₂ slurry 104M on the surface of another carbon nanotube fiber 104C.

Alternatively, the energy storage materials or the electrode materials may be deposited or coated on the flexible carrier using other methods such as physical/chemical vapour deposition, evaporation or spray coating, etc, or any suitable method as known by a skilled person.

In addition, an electrolyte 106 is also provided in the energy storage apparatus 100. The electrolyte 106 is arranged to physically separate the anode 102 from the cathode 104, and to facilitate ion transportation between the anode 102 and the cathode 104. The electrolyte 106 may be provided in the energy storage apparatus 100 by filling the electrolyte 106 material in an encapsulation 108 with the electrodes disposed therein. As one illustrative example, the encapsulation 108 may include a flexible plastic tube.

In an exemplary embodiment, a fabrication process of a rechargeable yarn-shaped Zn—MnO₂ battery (the energy storage apparatus 100) is provided. Firstly, carbon nanotube (CNT) yarns are produced by twisting seven CNT fibers into individual CNT yarns (the first and the second flexible carriers) after washing away the surfactant thoroughly with deionized (DI) water. In step 202, a flexible Zn anode 102 was fabricated by a facile electrodeposition method, in which a thin Zn film 102M was electroplated onto the surface of a first CNT yarn 102C in an aqueous solution of Zn(CH₃COO)₂ using an electrodeposition method, resulting in a composite CNT-Zn yarn 102. In step 204, MnO₂ slurry 104M was homogeneously coated on the surface of a second CNT yarn 104C to form a composite CNT-MnO₂ yarn or the cathode 104. In step 206, these two composite yarn electrodes 102, 104 are then placed in parallel and sealed in a flexible plastic tube 108 filled with the gelatine-based electrolyte 106. Finally, the encapsulation 108 may be sealed to protect the electrodes and the electrolyte 106 therein.

The continuous CNT fiber, which is an assembly of aligned CNTs, possesses the unique multifunctional merits of CNTs. CNTs are of light weight, excellent mechanical properties, chemical inertness, and high thermal and electrical conductivity, hence CNT fibers are preferably to be used in wire-shaped batteries and supercapacitors.

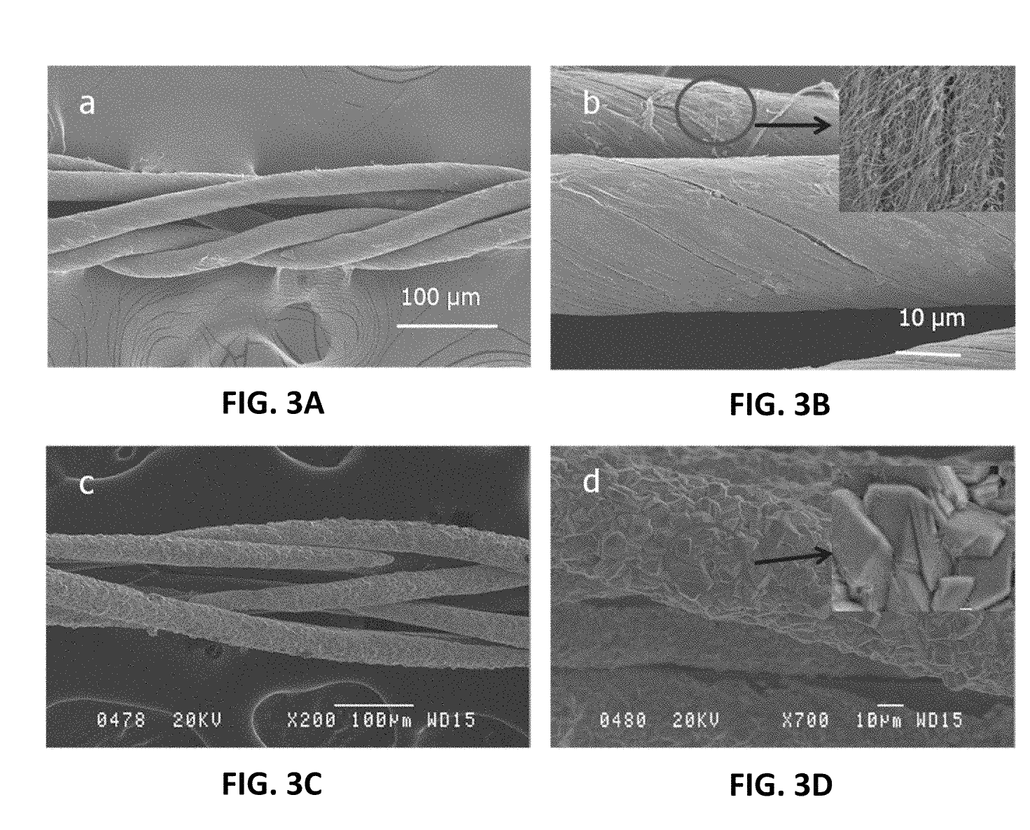

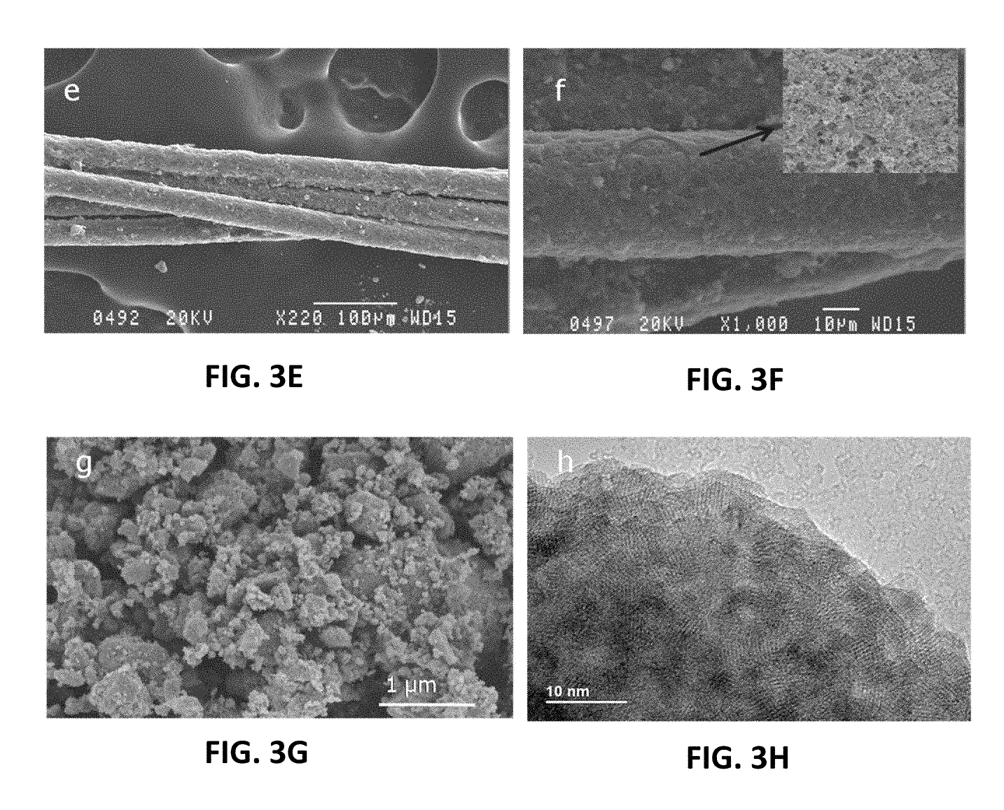

With reference to FIGS. 3A and 3B, there is shown scanning electron microscopy (SEM) images of the initial CNT yarns 102C, 104C. The CNT fiber has an average diameter of around 30 μm and a fairly compact structure, in which the carbon nanotubes are highly aligned. Advantageously, excellent mechanical properties, including high bending flexibility and high tensile strength, enable the pure CNT yarn to maintain its structural integrity after being bent, twisted, or knotted for multiple times.

With reference to FIGS. 3C and 3D, the morphology of the CNT—Zn composite yarn 102 at different magnifications is shown in the SEM images. Rock-like zinc deposits in discrete assemblies are uniformly coated on the surface of CNT yarn. Layer-by-layer growth of zinc on individual deposits can be observed from the image.

With reference to FIGS. 3E and 3F, these SEM images show that the CNT—MnO2 composite yarn 104 are fabricated with a diameter of approximately 100 μm.

With reference to FIG. 3G and 3H, there is shown SEM and TEM images of MnO₂ powder used to form the cathode electrode 104. MnO₂ particles aggregate together to form larger aggregates. The TEM image (FIG. 3G) shows that the as-prepared MnO₂ are amorphous with several nanometer in size.

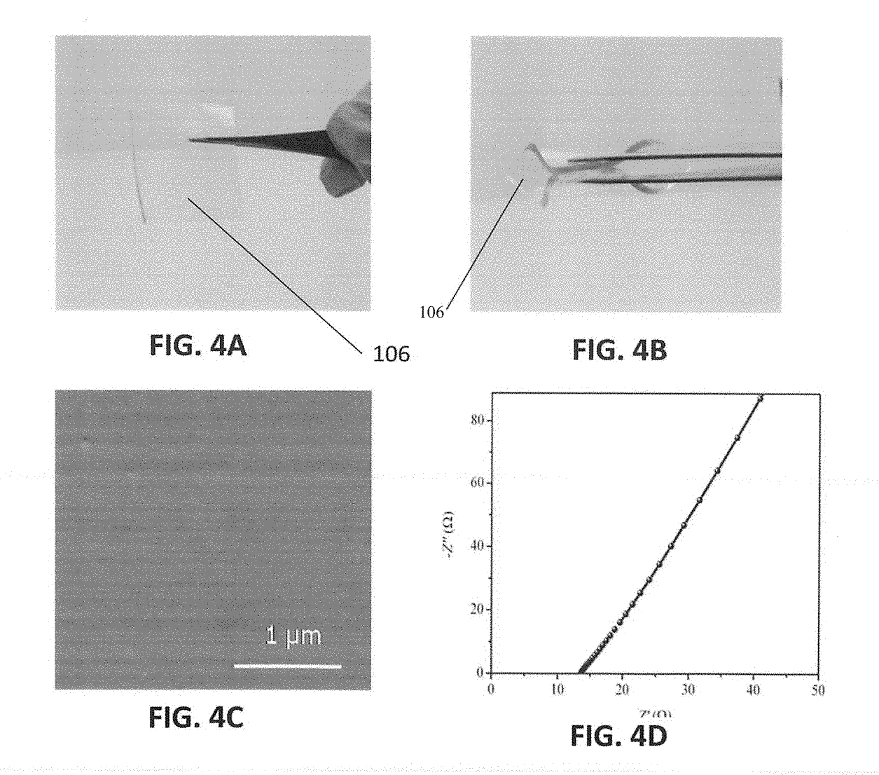

With reference to FIGS. 4A and 4B, there is shown photographic images of a solid state electrolyte 106. Preferably, the electrolyte 106 is gelatine-based, and more preferably, the electrolyte 106 is polymer-based, which comprises a metal salt (such as a divalent zinc salt, zinc sulfate and manganese sulfate) and a polymer or a polymer composite. The electrolyte 106 may be prepared by mixing a solution of the metal salt with the gelatine agent to form the gelatine- or polymer-based electrolyte 106. Referring to the Figures, it is shown that the GPE film is a thin and translucent all-solid-state electrolyte film 106 with excellent flexibility.

The SEM image of FIG. 4C illustrates that the as-prepared polymer electrolyte 106 is morphologically smooth and uniform, and no obvious phase separation was observed.

The ionic conductivity of the gelatine-based electrolyte 106 with Zn²⁺and Mn²⁺is evaluated. With reference to FIG. 4D, the ionic conductivity of GPE solid-state electrolyte 106 was obtained from the AC impedance spectra, showing a high ionic conductivity of 5.34×10⁻³ S·cm⁻¹ at room temperature. The electrolyte 106 includes a plurality of carboxyl group structures arranged to facilitate ion transportations between the anode 102 and the cathode 104. Such a high conductivity can be attributed to the presence of a great number of carboxyl group structure (—COO—) in this polymer electrolyte 106 for zinc ion to occupy and move freely between the electrodes.

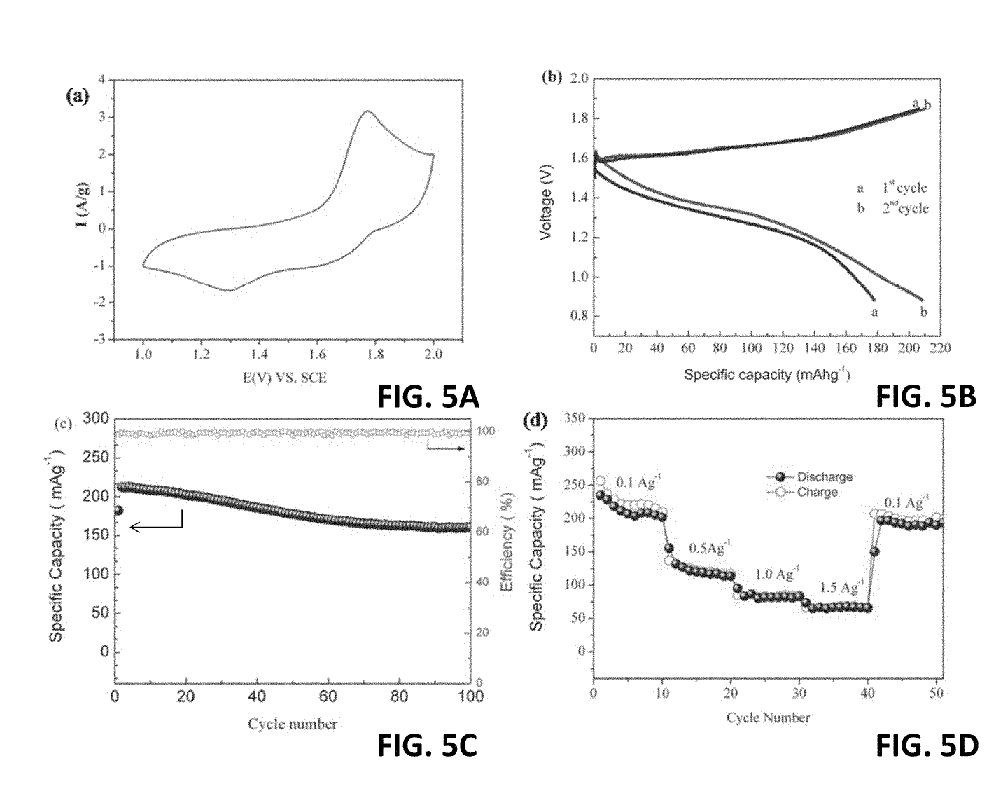

With reference to FIGS. 5A to 5D, there is shown the electrochemical properties of the rechargeable Zn/MnO₂ yarn battery. These properties were evaluated by cyclic voltammetry (CV) measurements and galvanostatic charge/discharge tests. There is shown a plot including a CV curve (the third cycle) at a sweep rate of 2 mV·s⁻1 within the potential range of 1.0 V˜2.0 V vs. Zn/Zn2+. Two distinct peaks were observed at around 1.75 V and 1.3 V from this curve, indicating that only one well-defined oxidation-reduction reaction appears in the charge/discharge process. This redox couple, at around 1.75 V and 1.3 V, should be attributed to the extraction/insertion of Zn²⁺ions into/from the tunnel of MnO₂ crystals, respectively.

The overall electrochemical reaction during discharging/charging of the rechargeable Zn/MnO₂ fiber battery cell is represented as follows:

Zn²⁺(aq)+2e⁻→Zn (s)

2MnO₂(s)+Zn²⁺+2e⁻→ZnMn₂O₄(s)

Referring to FIG. 5B, the rechargeable Zn/MnO₂ yarn battery shows rather different charge/discharge curves for the initial two cycles. The Zn/MnO₂ yarn battery displayed an open-circuit voltage (OCV) of about 1.52 V. One plateaus observed at 1.3 V in the discharge profiles may be attributed to zinc insertion into the MnO₂ cathode 104. This observation is consistent with the CV results shown in FIG. 5A.

Besides, a nontrivial overpotential of about 300 mV (0.2 Ag⁻¹) in the initial cycle, which are rarely seen in intercalation electrode materials. The total overpotential is taken roughly as the voltage difference between charge and discharge at the midpoint of the voltage profiles.

The cycle performance of the rechargeable Zn/MnO₂ batteries in terms of capacity retention and coulombic efficiency was also studied by a continuous cycling test at 0.2 Ag⁻¹ as shown in FIG. 5C. The initial discharge capacity was 177.8 mAh g⁻¹ when cycled at a current density of 0.2 Ag⁻¹. However, the second discharge capacity increased to 208 mAh g⁻¹ which is much higher than the initial capacity. Under long-term cycling, the Zn/MnO₂ yarn battery showed a steady capacity fading. The capacity fade displayed by the yarn battery during cycling is the same as that observed in other works. However, the coulombic efficiency is about 100% for all cycles, indicating a high utility of electric capability. After 100 cycles, the yarn battery can still display a capacity of 160 mAh g⁻¹.

In addition to the cyclability test, the rate performance of the yarn batteries was also measured at various current densities ranging between 0.1 and 1.5 Ag⁻¹ by cycling it ten times at each rate and the results are presented in FIG. 5D. The yarn battery exhibits high discharge capacities of 235, 155, 95, and 73 mAh g⁻¹ at current densities of 0.1 Ag⁻¹, 0.5 Ag⁻¹, 1 Ag ⁻¹ and 1.5 Ag ⁻¹ respectively. At the highest current density of 1.5 Ag ⁻¹, the yarn battery delivered a steady discharge capacity of 66 mAhg⁻¹. After being cycled at current densities as high as 1.5 Ag⁻¹, an average discharge capacity of 190 mAh g −1 that is equivalent to 86.7% of the initial average capacity (219 mAh g⁻¹) is still recovered at a current density of 0.1 Ag⁻¹. These observations clearly indicate the considerable structural adaptability of the yarn battery in delivering capacities at varying current rates.

Since the electrodes 102, 104, the electrolyte 106 and the encapsulation 108 which are mechanical flexible, the combination of these components may define a fabric yarn. A plurality of fabric yarn may combine to define a plane of fabric which may be suitable for making wearable electronic apparatus. Preferably, when the fabric yarn is bent, knotted, twisted or maintained substantially straight, the energy storage apparatus 100 or the battery is operable to charge and/or discharge, such that the operation of the wearable electronic apparatus may not interrupted when the battery fabric is bent or folded.

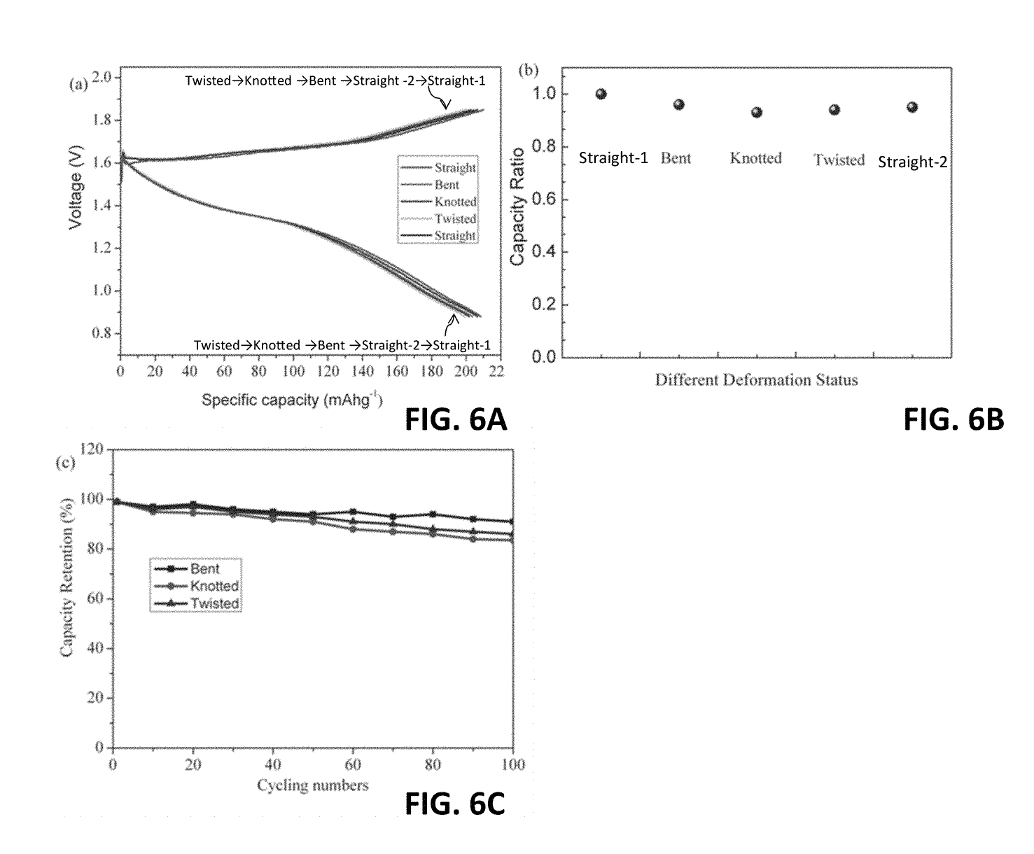

To meet the deformation demand, the yarn battery 100 was further subjected to a continuous deformation test, in the order of being straight, bent, knotted, twisted, and again straight. Referring to FIG. 6A, these discharge curves of the yarn battery almost remain unchanged under various deformation statuses. In FIG. 6B, the yarn battery shows 96%, 93% and 94% capacity retention at a current 0.2 Ag-1 on bending to 90°, knotting and twisting, respectively. After conforming to these nonplanar deformation tests, the yarn recovers to its original shape with over 95% of initial capacity obtained. Cycling test results under various mechanical deformations were shown in FIG. 6C. It retains over 91%, 84% and 86% of initial discharge capacity after 100 times under bending at 90°, knotting and twisting. The excellent stability and flexibility of this yarn battery is advantageous for the implementation of flexible and wearable devices.

These embodiments may be advantageous in that the energy storage apparatus are flexible and the components are in solid state, which allow the energy storage apparatus to be used in different electrical/electronic apparatus, especially in wearable electronic device. Therefore providing more flexibility in designing wearable electronic device when compare to conventional bulk battery.

Advantageously, the rechargeable yarn-based Zn/MnO₂ battery is of excellent safety and tailorability. The components of this battery, including MnO₂, Zn, and the mild gel electrolyte, are all low-cost, non-toxic, non-flammable and non-corrosive, which is much more environmentally friendly than lithium based batteries and Ni-Cd batteries.

The solid state components may also allow the energy storage apparatus to be flexibly cut into any length to fit with different designs and energy capacity requirement. The energy storage apparatus is provided with high flexibility, outstanding cycling stability and rate performance. In addition, the energy storage apparatus may be easily woven or knitted into conventional textile fabrics, and it also provides the capability to work under severe conditions, such as being cut, bent, or pressed, serving as a reliable power source for the flexible or wearable electronics.

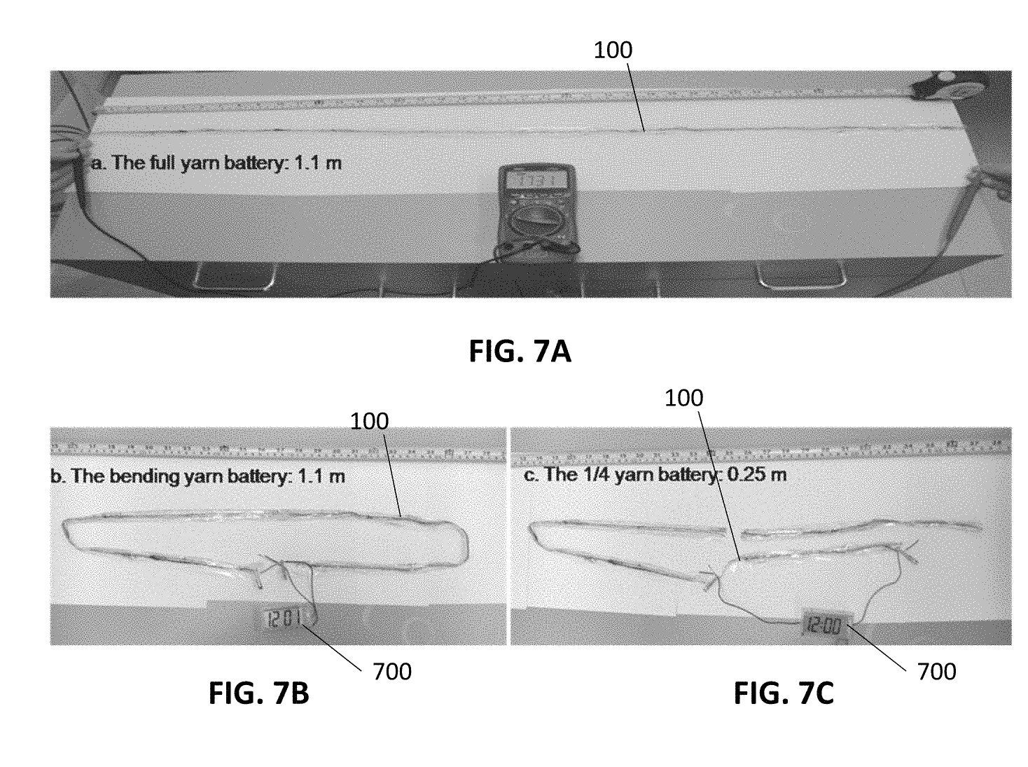

When experiencing severe conditions, such as cutting or blasting, the yarn battery can still operate. With reference to FIGS. 7A to 7C, the 1-meter long yarn battery 100 can drive an electronic watch. When it was cut into two parts, each of them can power the watch 700. When the yarn battery 100 was further cut into four to ten parts, each segmented battery can still drive the electronic watch 700, suggesting highly reliable power supply ability.

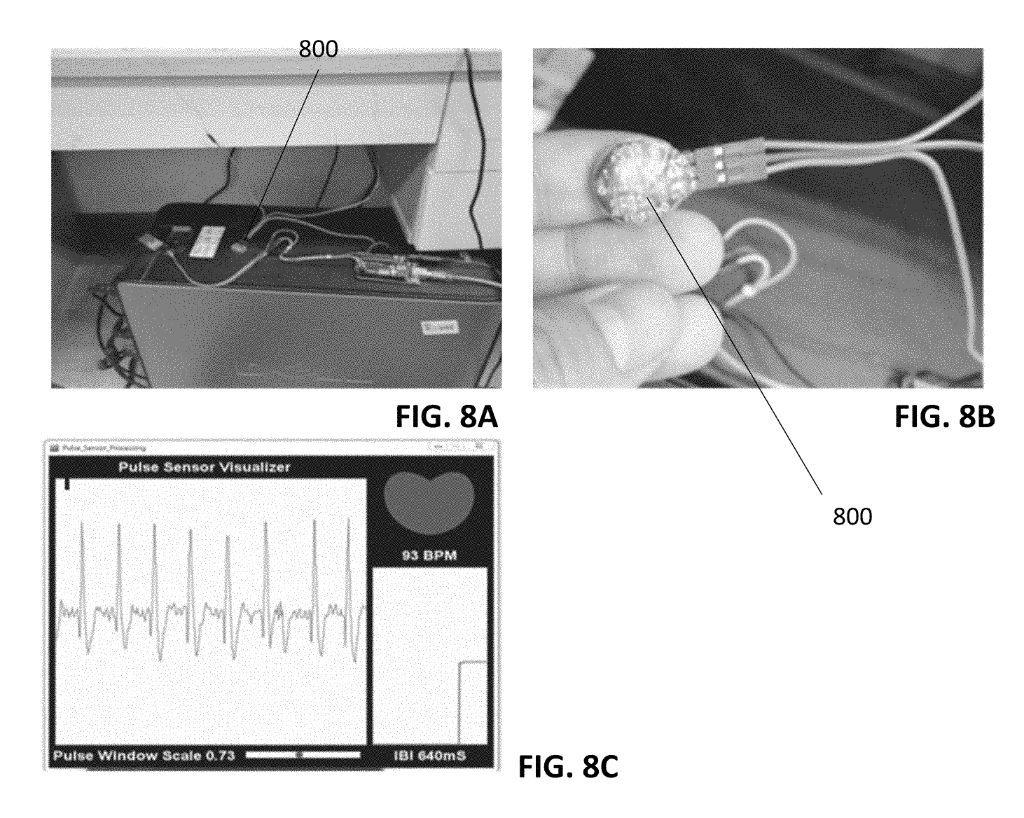

With reference to FIGS. 8A to 8C, when 5 segmented yarn batteries 100 are connected in series, the energy storage apparatus 100 may power a pulse sensor 800. This unique feature enables the yarn battery to have more applications in other fields, including sensors, implantable medical devices, robotics, etc.

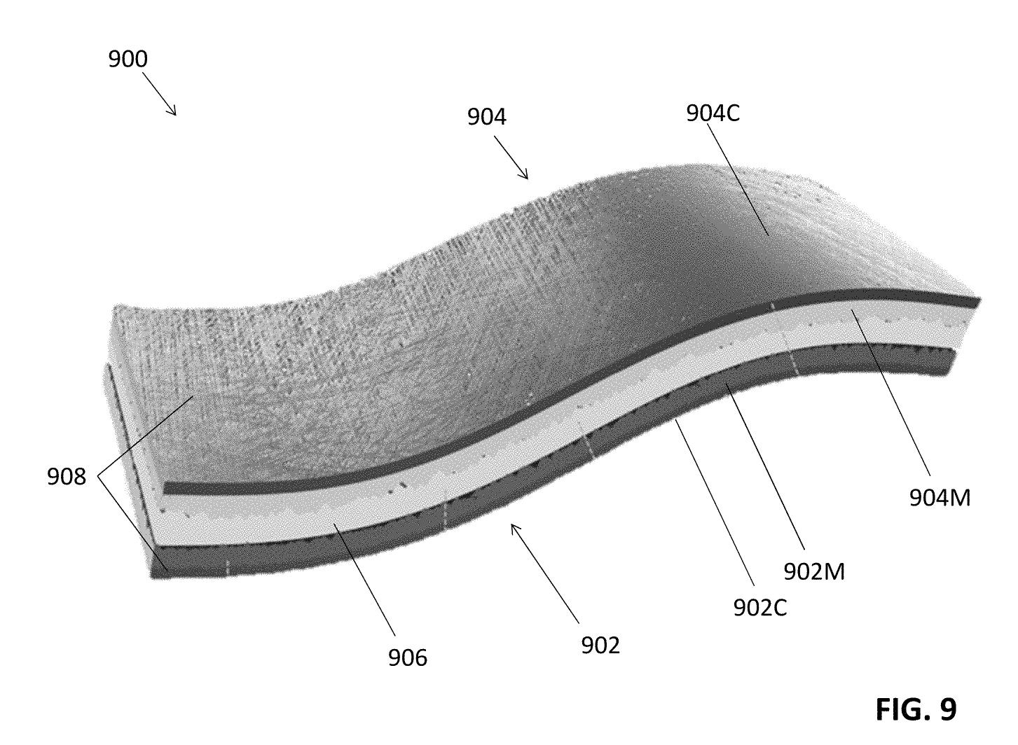

With reference to FIG. 9, there is shown an alternative embodiment of an energy storage apparatus 900. The energy storage apparatus 900 comprises a pair of electrodes including an anode 902 and a cathode 904; an electrolyte 906 adjacent to each of the pair of electrodes 902, 904; and an encapsulation 908 arranged to encapsulate the electrodes and the electrolyte; wherein the combination of the electrodes, the electrolyte and the encapsulation is mechanically flexible.

In this embodiment, the energy storage apparatus 900 or the battery is in a substantially planer shape, and the electrolyte 906 is sandwiched between the pair of electrodes 902, 904. The battery 900 includes an anode 902, a cathode 904, and a solid electrolyte 906 combined in a multi-layer stack form. The functions of these different layers are similar to the yarn-shape battery 100 of the previous example embodiment.

Similarly, the anode material 902M and the cathode material 904M may be coated on separate flexible carriers 902C, 904C, preferably on carbon nanotube (CNT) papers, sheets or films, to define the anode and the cathode electrodes. The flexible carriers are electrically conductive such that it also may be the current collectors of the energy storage apparatus 900. It is also preferable that the flexible carriers 902C, 904C are provided with a mechanical strength such that it may protect the energy storage apparatus 900 from impacts or damages. Alternatively, other conductive film such as metal sheets, graphene or polymer film coated with conductive material may be used as flexible carriers and/or the current collectors in the cathode and/or anode electrodes.

In this example, the outermost CNT papers 902C, 904C sandwich the anode material 902M, the cathode material 904M and the electrolyte 906 therebetween, and therefore the flexible carrier forms at least a part of the encapsulation 908. Optionally, additional encapsulations may be applied to further enhance the protection of the energy storage apparatus 900.

Preferably, the electrolyte 906 is gelatin- and/or polymer-based which may also include a metal salt to provide the necessary metal ions for the redox reaction. More preferably, the electrolyte 906 may include a hierarchical polymer structure. For example, the solid-state electrolyte may include a polyacrylonitrile (PAN) fiber membrane filled/injected with a gelatin material as discussed in the previous embodiment, which also contains the metal ions therein. In addition, the gelatin material may be grafted with polyacrylamide (PAM) so as to improve the electrical conductivity of the electrolyte.

In this example embodiment, PAN fiber membrane may be prepared by a facile electrospinning method. Briefly, 15 wt % PAN (Mw=150 000) may be dissolved in N,N-dimethylformamide (DMF) with continuous stirring at 70° C. for 5 hours, followed by an ultrasonic treatment for 2 hour. After that, the PAN solution was sequentially electrospun onto the target rotating collector with a flow rate of 1.0 mLh⁻¹ by using a electrospinning machine. The obtained PAN-based fiber membrane may then be removed from the collector and dried at 60° C. for 12 hours under vacuum before further use.

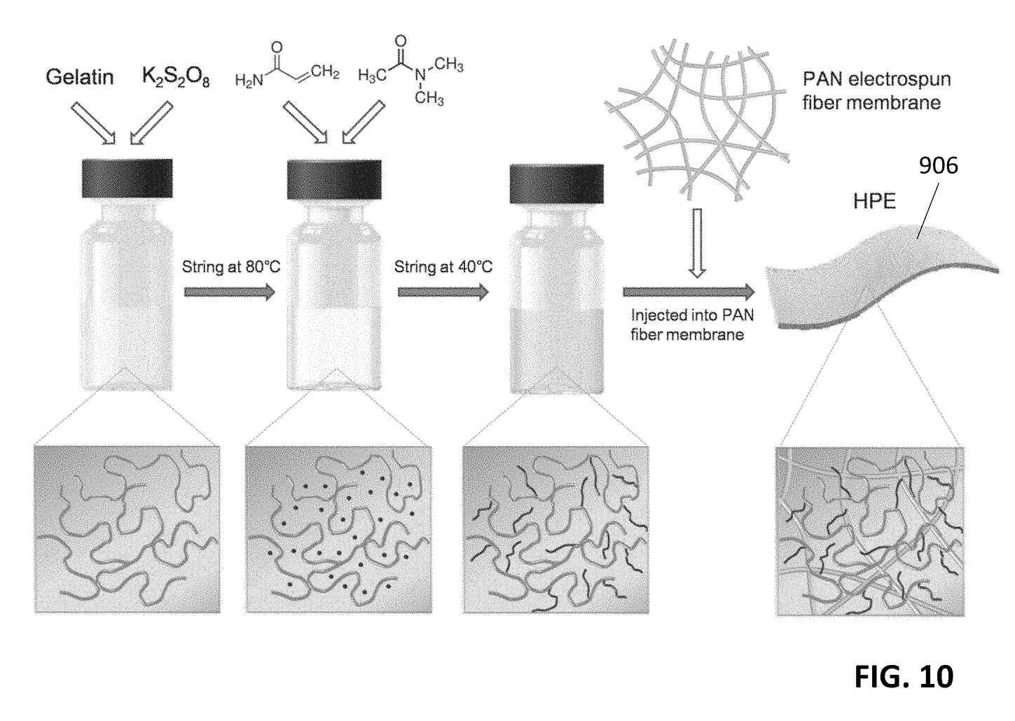

With reference to FIG. 10, there is provided an example fabrication process of the solid-state polymer electrolyte (SPE) film of the energy storage apparatus 900. Firstly, pristine gelatin and potassium persulfate (KPS) are added into the mixture solution of metal salts—ZnSO₄ and MnSO₄, followed by extensive stirring at 80° C. until gelatin and potassium persulfate are well dissolved. Secondly, to graft PAM onto the gelatin chains, acryl amide (AM) monomers and N,N′-methylenebisacrylamide (BIS) may be subsequently added into the above solution. After stirring at 40° C. for 5 hours, the mixture may be evacuated and injected into an electrospun PAN membrane, followed by heating at 60° C. for 10 to 20 minutes. Finally, a cross-linked 3D framework structure filled with gelatin-g-PAM hydrogel may be formed in the pores of PAN fiber membrane, and a hierarchical polymer electrolyte (HPE) with good flexibility may be obtained.

In an alternative example fabrication process, HPE may be synthesized by an in-situ synthesis method. 2 grams of gelatin is added into 15 mL mixture solution of 1 mol/L ZnSO₄ and 0.1 mol/L MnSO₄, followed by extensive stirring at 80° C. until all the gelatin powder are well dissolved. Then, 2 mg N,N′-methylenebisacrylamide (BIS), 2 g acryl amide (AM) and 20 mg ammonium persulfate (APS) may be sequentially added into the solution. After that, the mixture may be stirred at 40° C. for 5 hours, evacuated, and injected into an electrospun PAN membrane heated at 70° C. for 2 hours. Finally, a crosslinked 3D framework structure filled by Gelatin/PAM-based solid electrolyte may be formed in the pores of electrospun PAN fiber membrane, and a uniform and flexible all-solid-state electrolyte film was obtained.

In another example, a a gelatin electrolyte (GE) 906 may be prepared by adding pristine gelatin into the mixture solution of ZnSO₄ and MnSO₄, followed by extensive stirring at 80° C. until gelatin were dissolved. The inventor has carried out experiments to evaluate the performances of different energy storage apparatuses 900 with HPE and GE included.

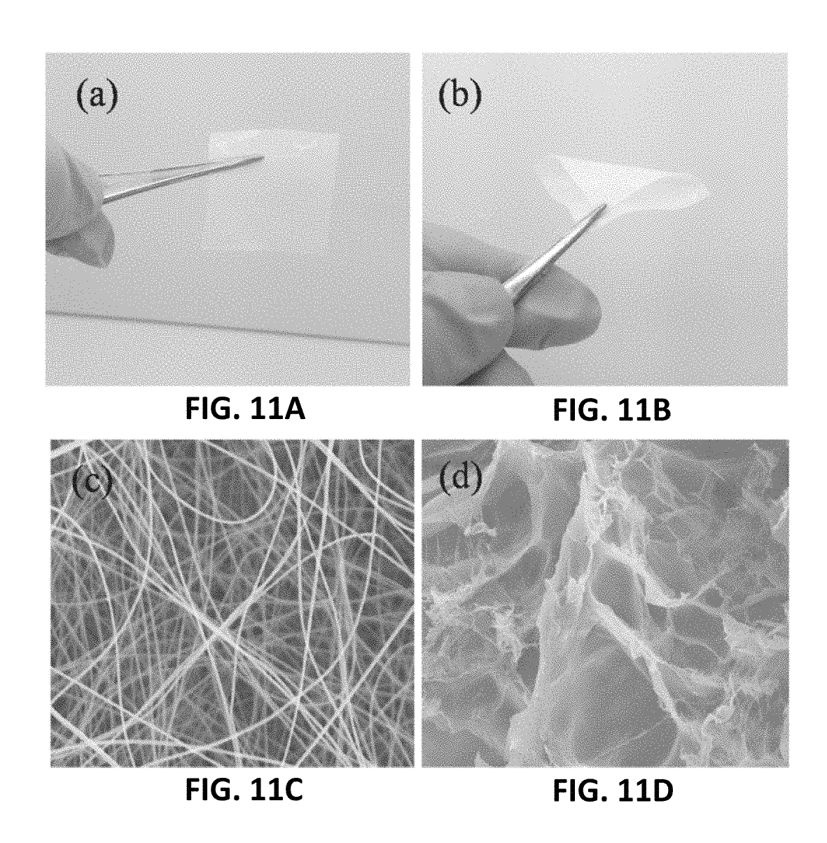

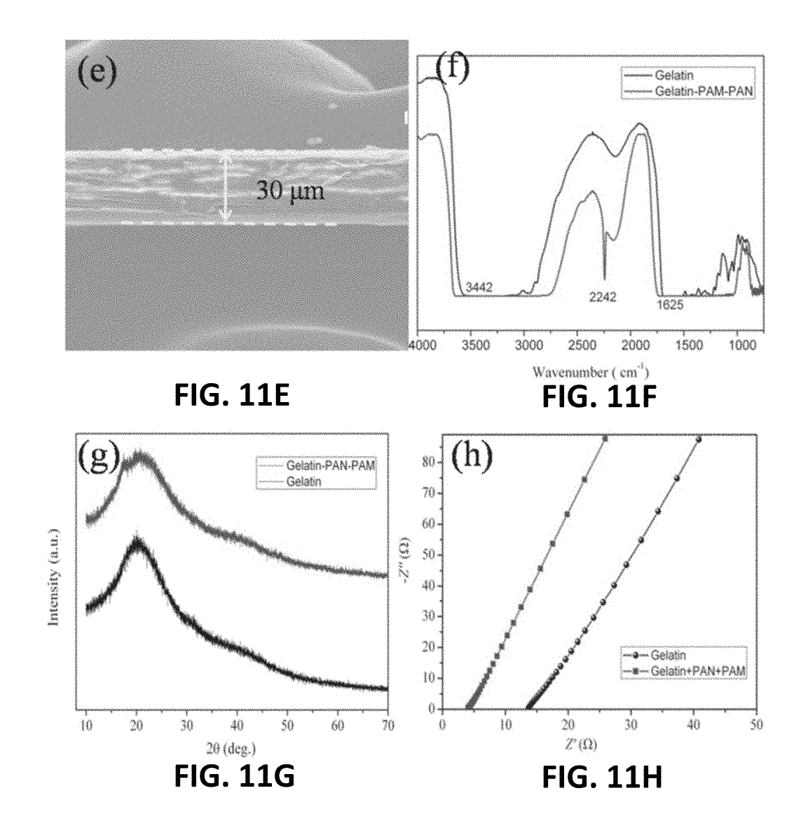

With reference to FIGS. 11A and 11B, there is shown optical images of the SPE film 906, revealing that a uniform, thin, and white all-solid-state electrolyte film with excellent flexibility may be obtained by combining the gelatin-g-PAM solid electrolyte with the PAN fiber membrane.

With reference to FIG. 11C, the scanning electron microscopy (SEM) image shows that the PAN fiber membrane is composed of randomly oriented fibers with an average diameter of about 600 nm. Referring to FIG. 11D, the SEM image of gelatin-g-PAM hydrogel reveals a high porosity characteristic. Compared with the morphology of pristine gelatin, this highly porous and three-dimensional architecture may contribute to a higher uptake ability of water and rapid ion transport pathways. The cross-section image of SPE film as shown in FIG. 11E demonstrates that the gelatin-g-PAM solid electrolyte is fully filled into the pores of the PAN fiber membrane and forms a compact film with a thickness of 30 μm.

Fourier-transform infrared spectrum (FTIR) technique may be used to elucidate the polymerization mechanism of gelatin-g-PAM/PAN solid electrolyte. Referring to FIG. 11F, the peak at 3423 cm⁻¹ in the gelatin-g-PAM copolymer is the overlap of —N—H stretching group of gelatin and PAM. The peak at 1625 cm⁻¹ in the gelatin-g-PAM is the overlap resulting from the carboxyl group 1592 cm⁻¹ of gelatin and amide group (1625 cm cm⁻¹) of PAM. There are a set of similar peaks at 1068 cm⁻¹ which is the CH—O—CH2 group resulting from grafting reaction between the hydroxyl group located in anhydroglucose C2 position and the p band of PAM. The primary peaks existed in the gelatin-g-PAM, suggesting formation of aether (CH—O—CH2) during the grafting copolymerization.

With reference to the X-ray diffraction patterns of gelatin and gelatin-g-PAM films as illustrated in FIG. 11G, the gelatin-g-PAM has the similar amorphous pattern with the pristine gelatin, and no obvious peak corresponding to additional crystalline phase can be identified in the case of gelatin-g-PAM solid electrolyte. However, there is a shift peak at 2θ=23° in gelatin-g-PAM corresponding to the position at 2θ=21° observed in gelatin pattern. This may be caused by a rearrangement in the morphology of the polymeric chain after grafting of PAM to gelatin.

The ionic conductivities with Zn²⁺and Mn²⁺ions play a vital role in fabricating a high-performance solid-state battery. The ionic conductivity of the hierarchical SPE film with Zn²⁺and Mn²⁺were evaluated. Referring to FIG. 11H, the ionic conductivities of HPE and GE films were obtained from the AC impedance spectra. It can be seen that HPE film exhibits a much higher ionic conductivity of 1.76×10⁻² S cm⁻¹ at room temperature, much larger than that of pristine GE (5.68×10⁻³ S cm ⁻¹). The conductivity of the hierarchical electrolyte is very high and almost comparable with that of the liquid electrolyte.

Both the gelatin material and the polyacrylamide may increase a phydrophilicity of the electrolyte 906, thus increasing the ionic conductivity and the electrical conductivity of the electrolyte 906. As a biopolymer mixture derived from collagen, gelatin possess a high degree of hydrophilicity due to the presence of a large number of hydrophilic pendant groups. After grafting acrylamide polymer onto gelatin chains, the kinds and amounts of hydrophilic groups of polymer hosts are further increased, which contributes to a higher water retention ratio in the polymer matrix, leading to an enhanced ionic conductivity. Moreover, the open channels of three-dimensional hierarchical architecture and the continuous ionic pathways within the hydrogel network may also facilitate the ionic transport.

The cathode 904 includes energy storage material 904M such as manganese oxide or a MnO₂/C composite. The energy storage material 904M may be synthesized by a modified co-precipitation and hydrothermal method. In an example synthesis routine of α-MnO₂ nanorods, 2.94 g Mn(CH3COO)₂·4H₂O may be added into 150 mL deionized water under continuous stirring for 0.5 hours. Subsequently, the above solution may be added drop-wise into an aqueous solution prepared by dissolving 1.27 g KMnO4 into 80 mL deionized water and followed by stirring for half an hour. The mixed solution may then be processed intensively with an ultrasonic mixer for 10 minutes. The solution may then be transferred to a Teflon-lined autoclave and heated at 120° C. for 12 hours. After cooling, the obtained dark brown precipitate may be washed several times by deionized water and dried at 40° C. in a vacuum oven for 8 hours to finally obtain the MnO₂/C composites.

The active material of cathode 904, manganese oxide, is a key component for rechargeable Zn/MnO₂ batteries. Different types of MnO₂ (amorphous, α-phase, γ-phase) may be included as cathode materials 904M. Preferably, α-MnO₂ nanorods/carbon nanotube (CNT) nanocomposites may be synthesized using a modified coprecipitation hydrothermal method and used as cathode materials in Zn/MnO₂ batteries.

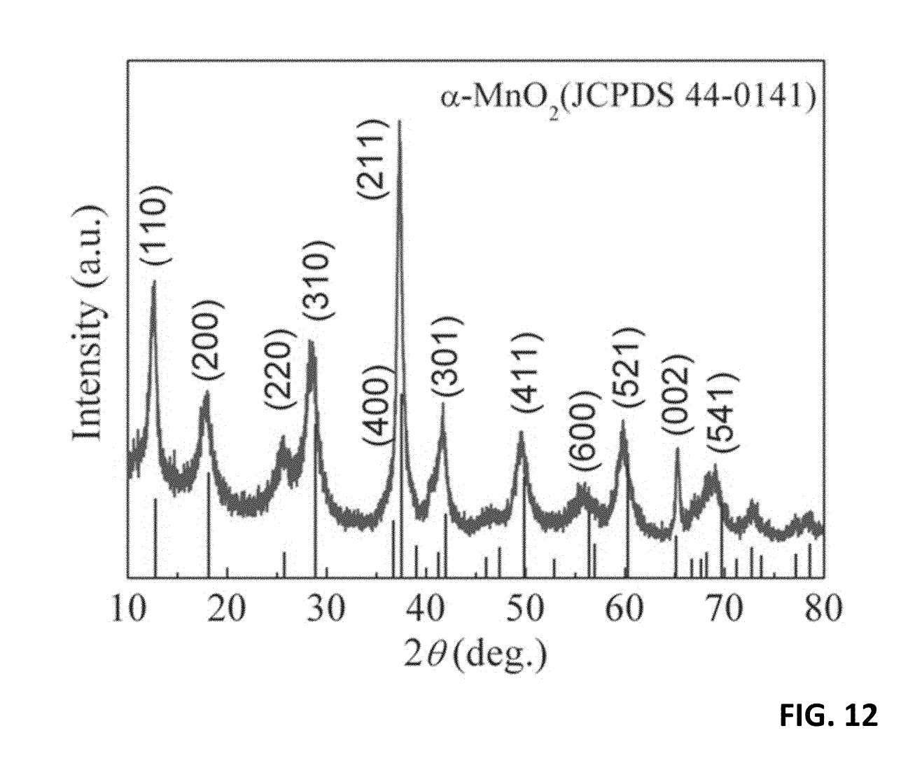

With reference to FIG. 12, the XRD pattern shows the crystalline structure of the as-prepared MnO₂/CNT composites. The diffraction peaks of the sample can be well-indexed to the characteristic peaks of α-MnO₂. Besides, the peak observed at 25.9° should be assigned to the (002) planes of graphite carbon, which indicates the presence of carbon nanotube in the composites.

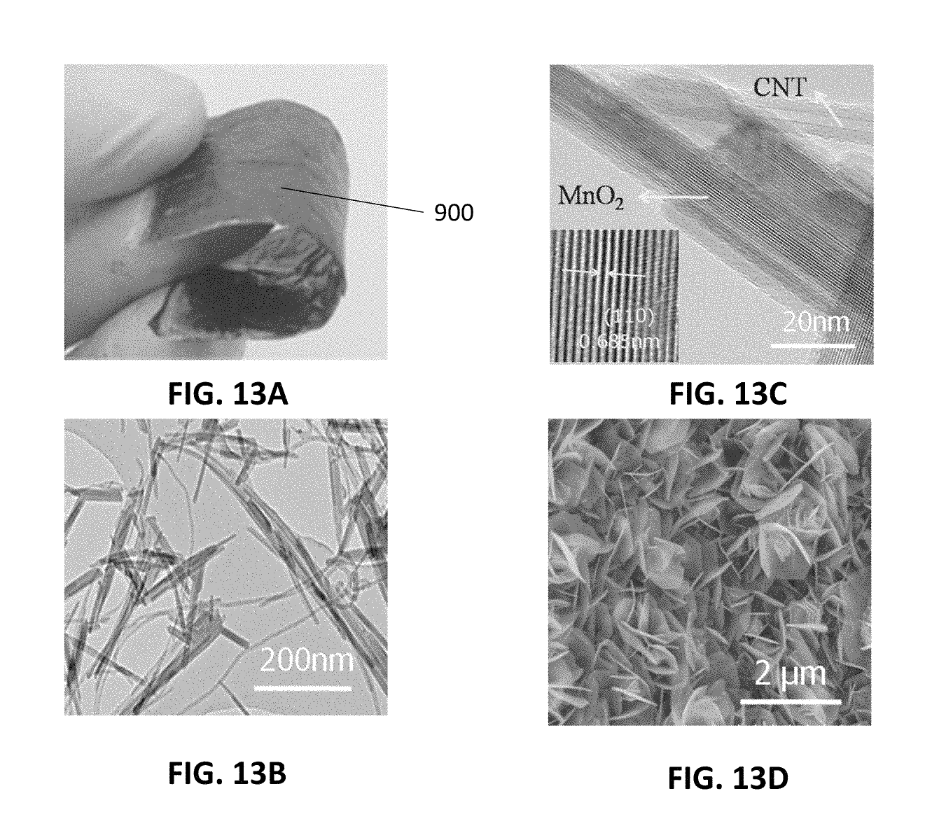

With reference to FIGS. 13B and 13C, the morphology and size distribution of the sample were characterized by transmission electron microscopy (TEM). The morphology of the product showed rod shaped particles with approximately 20 nm of width, while their length range from 100 nm to 500 nm. The 1D α-MnO₂ nanorods with a lattice distance of 0.685 nm corresponding to the (110) plane of α-MnO₂. This indicates that the as-prepared α-MnO₂ is highly crystalline, with the (110) axis as the preferred orientation for 1D nanaorods.

To fabricate the cathodes 904, MnO₂/C composites, acetylene blacks and polytetrafluoroethylene (PTFE) binder may be mixed in an appropriate ratio (for example 7:2:1 in weight ratio) with some deionized water added. The mixtures may then be stirred for 3 hours and coated on a piece of stainless-steel film (30 μm in thickness) or on a CNT paper. Finally, the coated films may be dried at 65° C. in vacuum and may be cut into small square electrodes (size 1 cm×1 cm).

In this example, the cathode material 904M is blade-coated on the surface of the second flexible carrier 904C. Alternatively, any suitable coating/printing/deposition method may be adopted to dispose the cathode material onto the surface of the flexible carrier.

The anode 902 may be fabricate by using a facile electrochemical deposition of zinc metal on CNT paper substrate 902C. A two-electrode setup may be used for Zn electroplating: CNT paper substrate may be used as a working electrode, while a zinc plate (purity>99.99%) may be used as both counter and reference electrode. Aqueous solution containing 1 M Zn₂SO₄ and 1 M KCl may be used as electrolyte. Electroplating may be performed at 5 mA-cm⁻² for 400 seconds using an electrochemical workstation.

With reference to FIG. 13D, there is shown an SEM image of zinc deposited on CNT papers. The electroplated zinc exists as uniform nanosheets with porous structure which facilitates the electrolyte penetration and fast charge transport.

Advantageously, continuous CNT paper, which is an assembly of interweaved CNTs, exhibits unique characteristics including light weight, high flexibility, exceptional mechanical properties and high electrical conductivity, may be used as an ideal substrate or a flexible carrier in flexible energy storage and conversion devices. Therefore, CNT papers may be adopted as the current collectors instead of other metal supports and/or heavy Zn metal foil, which greatly enhance the energy density and flexibility of the full device.

With such advantages, Zn anode 902 may be fabricated by depositing a uniform and thin zinc film on the surface of CNT paper via a facile electroplating approach. While for MnO₂ cathode, α-MnO₂/CNT composites may be stirred with acetylene black, water-based adhesives and water to form homogeneous slurry, followed by spreading the slurry on a CNT paper substrate through a blade-coating process to form the cathode 904. The solid-state rechargeable Zn/MnO₂ battery 900 may then assembled as a multi-layer stack in the open air by using the as-prepared Zn anode 902, MnO₂ cathode 904 and the hierarchical polymer electrolyte 906. Referring to FIG. 13A, the energy storage apparatus 900 exhibits a good flexibility and an ultrathin dimension.

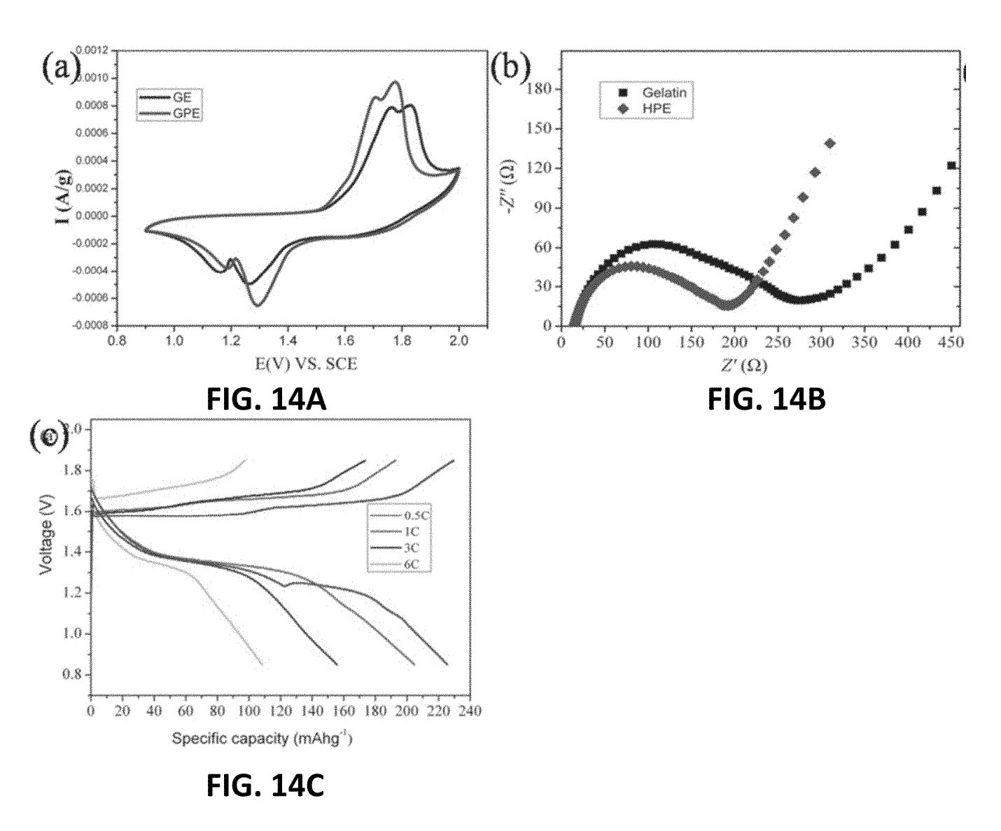

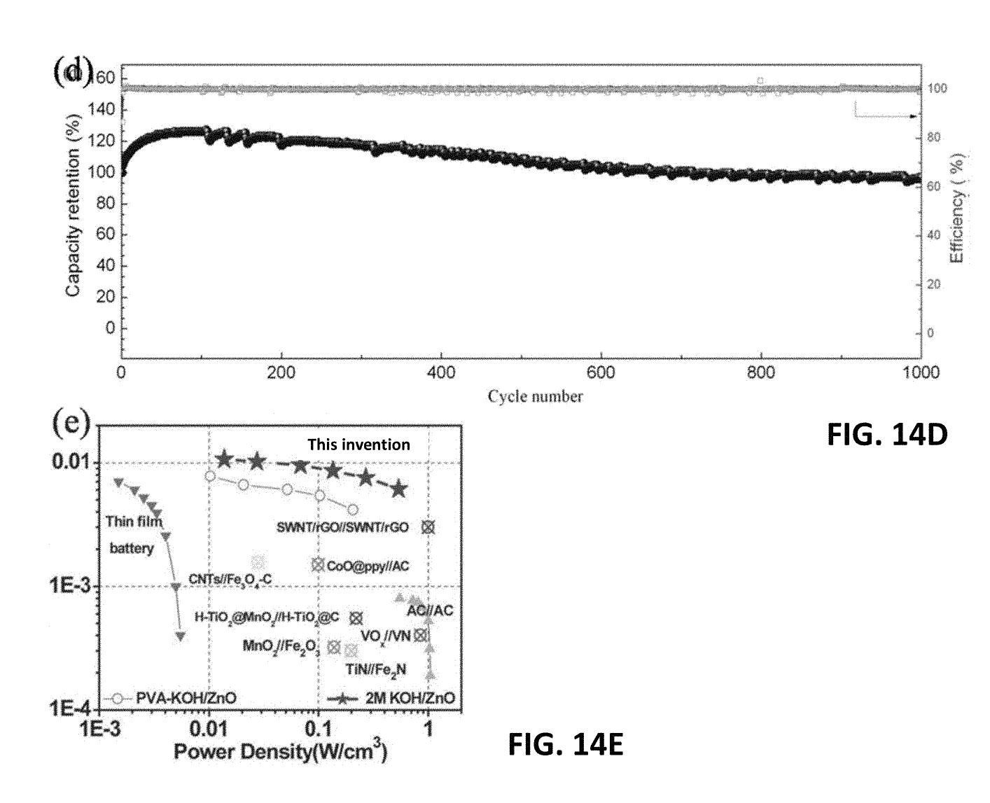

The inventors have performed various experiments to evaluate the performance of the energy storage device in accordance with the embodiments of the present invention. With reference to FIG. 14A, there is shown the cyclic voltammetry (CV) curves of Zn/MnO₂ batteries with gelatin and HPE electrolytes, revealing similar redox behaviors. Two redox peaks were observed in the CV curves, which indicate that two reduction-oxidation reactions occur in the electrochemical process. The voltage difference between the anodic and cathodic peaks (ΔEₚ) reflects the degree of polarization of the electrode. It is clearly seen that the battery with HPE has a much lower ΔEₚ than the one with gelatin electrolyte, suggesting good electrochemical reaction kinetics.

With reference to FIG. 14B, the electrochemical impendence spectroscopy (EIS) results of the Zn/MnO₂ batteries with gelatin and HPE are shown. The intersection of the EIS diagram with real axis at the high frequency signifies the bulk resistance of the electrochemical system (R_{b}), while the amplitude of the depressed semicircle represents the interfacial resistance between the solid electrolyte and electrodes (Rᵢ). It can be seen from the EIS plot that both R_{b} and Rᵢ of the battery with HPE are lower than those of the battery with pristine gelatin electrolyte. This indicate that the hierarchical polymer electrolyte with higher water holding capacity and porous three-dimensional structure is more effective to maintain a good electrode/electrolyte interface than the pristine gelatin electrolyte, which leads to a higher ion diffusion coefficient and faster electrochemical reaction kinetic.

With reference to FIG. 14C, there is shown a plot including charge and discharge curves of the Zn—MnO₂ batteries with SPE at different rates ranging from 0.5 C to 6 C (1 C=308 mAh/g), in which all the curves demonstrate characteristic charge and discharge plateaus at ≈1.6 V and ≈1.4 V, respectively. The solid-state energy storage apparatus 900 with HPE shows an excellent rate capability, delivering high capacities of 280, 231, 207, 161 and 113 mAh/g⁻1 at 0.2 C, 0.5 C, 1 C, 3 C and 10 C, respectively. More impressively, the solid-state Zn/MnO₂ battery based on HPE also exhibits good long-term cycling stability.

With reference to FIG. 14D, the Zn/MnO2 battery with SPE demonstrated a high capacity retention of 97% after 1,000 cycles at a rate of 6 C. The good cycling stability is due to that the polymer network of gelatin-g-PAM/PAN electrolyte can effectively hold the water and hinder its leakage and volatilization, which maintains a good stability and high ionic conductivity throughout the long-term charge/discharge test. In the meantime, the presence of CNT in the MnO₂/CNT composites effectively enhances the conductivity and electron transfer efficiency of the MnO₂ cathode, and further improves the stability of the whole battery.

With reference to FIG. 14E, there is shown a comparison of volumetric power (P) and energy densities (E) of flexible and rechargeable Zn/MnO₂ battery with solid-state HPE film other example batteries. The maximum volumetric power and energy densities of our device are calculated to be 7.47 mWh cm⁻³ and 0.52 W cm⁻³, which are much higher than the values obtained in other example flexible ES devices. The values are also higher than those values of the thin film Lithium battery. These exceptional electrochemical performances indicate that the rechargeable Zn/MnO₂ system based on a solid-state electrolyte is very promising for a high-performance, long-life, low-cost and environmentally-friendly energy storage.

The Cyclic voltammetry curves and electrochemical impedance spectroscopy (100 kHz to 0.1 Hz) were conducted using an electrochemical workstation (CHI 760D). Electrochemical performance of the solid-state battery was examined based on galvanostatic testing of CR2032-type coin cells in the voltage range of 0.85V −1.9 V using a Land 2001A battery testing system at 24° C.

The inventors have also evaluated anti-destructive and reliability features of the energy storage apparatus 900 in accordance with the embodiments of the present invention. Advantageously, the rechargeable solid-state Zn/MnO₂ battery is provided with enhanced safety and reliability, therefore may be used in extreme conditions. The experiments include a series of destructive tests, washing test and combustion test.

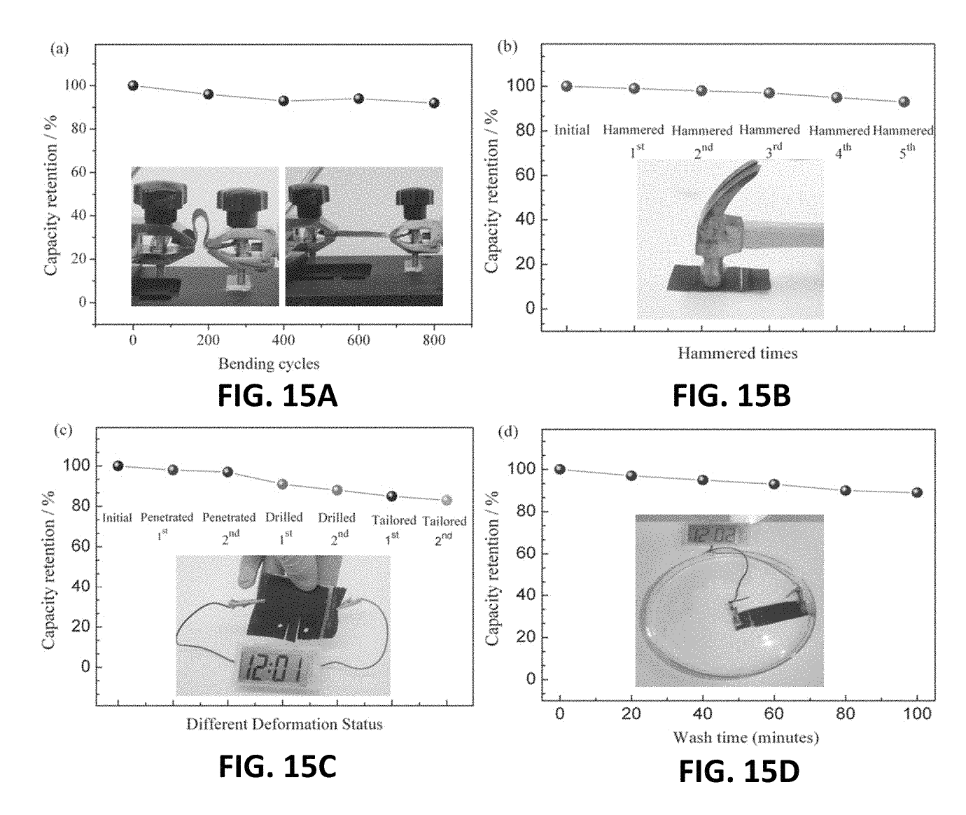

With reference to FIG. 15A, there is only a minor loss in the capacity of the Zn/MnO₂ battery after bending for 100 cycles. Capacitance of over 90% is retained after bending for 800 times, which indicates excellent electrochemical stability and mechanical flexibility.

To further investigate whether the solid battery can withstand the sudden hit or impact that normally occurs in the real situations, the solid-state Zn/MnO₂ batteries were subject to a consecutive hammering test. With reference to FIG. 15B, it is shown that the capacity retention of the Zn/MnO₂ battery still remains 91% after 5 times of violent hammering (3 Mpa). Even when the battery suffers from 15 times of violent hammering, it can still operate and be able to power an electronic watch.

With reference to FIG. 15C, the capacity retention of the Zn/MnO₂ battery under a destructive perforating test. In this experiment, the battery was prepared with three to five through-holes (diameter: 2 mm). It was observed that capacity retention decrease as the number of holes increase. However, the solid-state Zn/MnO₂ battery still presented over 80% capacity retention and was capable of powering the electronic watch.

Washability of the flexible battery 900 is also considered as a key factor for real application. Although the textile engineering may enable ES devices to be wearable, poor washability would impose a serious restriction on bringing wearable devices into reality. In order to evaluate their washability and mechanical stability in water, washing tests of solid Zn/MnO₂ batteries with SPE were performed. Referring to FIG. 15D, the whole battery was put in a glass vessel full of water, followed by soaking and stirring for over an hour. It was observed that even the battery suffers from a continuous washing for 100 minutes, the battery still keeps its original appearance and retains 81% capacitance. Moreover, it was able to power the electronic watch throughout the test.

These embodiments provide flexible and rechargeable solid-state Zn/MnO₂ batteries with a hierarchical polymer electrolyte (HPE) and carbon nanotube (CNT) paper based electrodes. Advantageously, the hierarchical polymer electrolyte not only was an effective separator but also served as an efficient ionic conductor, providing high flexibility, high safety as well as high ionic conductivity for the battery. The solid-state battery may exhibit a high specific capacity of 280 mAhg⁻¹ at 0.2 C and high capacity retention of 97% after 1000 cycles.

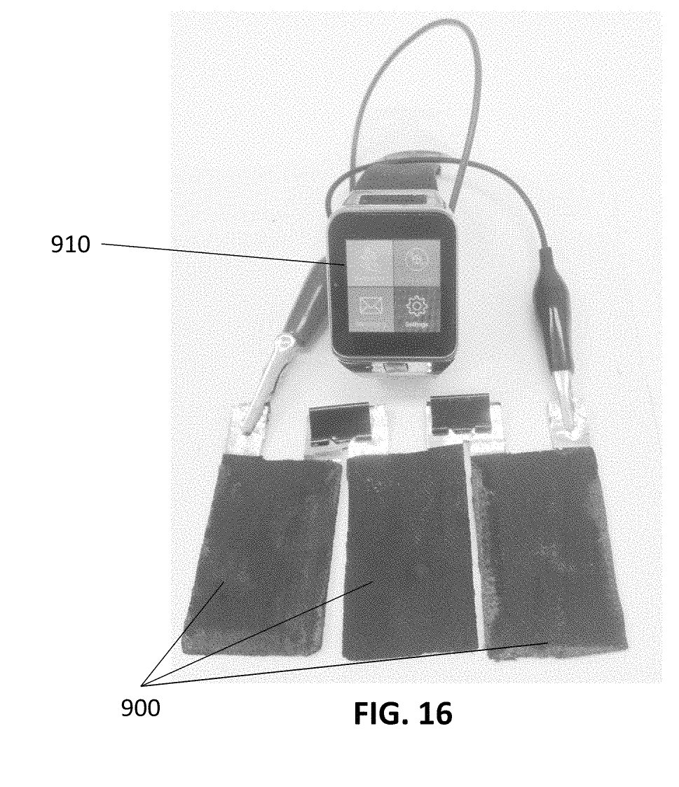

Moreover, the energy storage apparatus exhibits high flexibility, greatly enhanced safety and serves as a reliable power source to work under severe conditions, such as being bent, hammered, punctured, tailored or even washed. With reference to FIG. 16, multiple solid-state rechargeable Zn/MnO₂ batteries (with a size of 2.5 cm×5.0 cm) may be connected in series to power an electronic device such as a smart watch 910. The energy storage apparatus 900 may be provided in different sizes with any voltage and/or capacity for different applications.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An energy storage apparatus comprising a pair of electrodes including an anode and a cathode; an electrolyte at least partially surrounding or adjacent to each of the pair of electrodes; and an encapsulation arranged to encapsulate the electrodes and the electrolyte; wherein the combination of the electrodes, the electrolyte and the encapsulation is mechanically flexible.

2. An energy storage apparatus in accordance with claim 1, wherein the electrodes, the electrolyte and the encapsulation are in a solid state.

3. An energy storage apparatus in accordance with claim 1, wherein each the anode and/or the cathode comprises a flexible carrier arranged to retain an energy storage material thereon.

4. An energy storage apparatus in accordance with claim 3, wherein the flexible carrier includes an electrical conductor.

5. An energy storage apparatus in accordance with claim 3, wherein the flexible carrier includes a shape of a fiber.

6. An energy storage apparatus in accordance with claim 3, wherein the flexible carrier includes one or more carbon nanotubes.

7. An energy storage apparatus in accordance with claim 3, wherein the energy storage material is retained on a surface of the flexible carrier.

8. An energy storage apparatus 900 in accordance with claim 3, wherein the flexible carrier forms at least a part of the encapsulation.

9. An energy storage apparatus in accordance with claim 3, wherein the energy storage material includes an anode material and a cathode material in the anode and the cathode respectively.

10. An energy storage apparatus in accordance with claim 9, wherein the anode material includes at least one of zinc, zinc alloy, a zinc composite and an electrical conductive additive.

11. An energy storage apparatus in accordance with claim 9, wherein the cathode material includes manganese oxide.

12. An energy storage apparatus in accordance with claim 1, wherein the electrolyte is gelatin-based.

13. An energy storage apparatus in accordance with claim 1, wherein the electrolyte is polymer-based.

14. An energy storage apparatus in accordance with claim 13, wherein the electrolyte comprises a metal salt and at least one of a polymer or a polymer composite.

15. An energy storage apparatus in accordance with claim 14, wherein the electrolyte includes a hierarchical polymer structure.

16. An energy storage apparatus 900 in accordance with claim 15, wherein the electrolyte includes a gelatin material.

17. An energy storage apparatus in accordance with claim 16, wherein the gelatin material is grafted with polyacrylamide.

18. An energy storage apparatus in accordance with claim 17, wherein the gelatin material and/or the polyacrylamide are arranged to increase an electrical conductivity of the electrolyte.

19. An energy storage apparatus in accordance with claim 18, wherein the gelatin material and/or the polyacrylamide are arranged to increase a hydrophilicity and therefore an ionic conductivity of the electrolyte.

20. An energy storage apparatus in accordance with claim 16, wherein the gelatin material is filled in a polyacrylonitrile fiber membrane.

21. An energy storage apparatus in accordance with claim 1, wherein the electrolyte is arranged to physically separate the anode from the cathode.

22. An energy storage apparatus in accordance with claim 1, wherein the electrolyte is arrange to facilitate ion transportations between the anode and the cathode.

23. An energy storage apparatus in accordance with claim 22, wherein the electrolyte includes a plurality of carboxyl group structures arranged to facilitate ion transportations between the anode and the cathode.

24. An energy storage apparatus in accordance with claim 1, wherein the energy storage apparatus is rechargeable.

25. An energy storage apparatus in accordance with claim 1, wherein the cathode is arranged to reversibly store and release anion provided by the anode during a charging process and a discharging process respectively.

26. An energy storage apparatus in accordance with claim 1, wherein the combination of the electrodes, the electrolyte and the encapsulation defines a fabric yarn.

27. An energy storage apparatus in accordance with claim 26, wherein the energy storage apparatus is operable to charge and/or discharge when the fabric yarn is bent, knotted, twisted or maintained substantially straight.

28. An energy storage apparatus in accordance with claim 26, comprising a plurality of the fabric yarn combined to define a plane of fabric.

29. A method for fabricating an energy storage apparatus in accordance with claim 9, comprising the steps of:
depositing an anode material on a first flexible carrier to define the anode; and
depositing a cathode material on a second flexible carrier to define the cathode.

30. A method for fabricating an energy storage apparatus in accordance with claim 29, wherein the anode material is electroplated on a surface of the first flexible carrier.

31. A method for fabricating an energy storage apparatus in accordance with claim 30, wherein a layer of zinc is electroplated onto the first flexible carrier in an aqueous solution of Zn(CH₃COO)₂.

32. A method for fabricating an energy storage apparatus in accordance with claim 29, wherein the cathode material is coated on a surface of the second flexible carrier.

33. A method for fabricating an energy storage apparatus in accordance with claim 32, wherein a layer of manganese oxide is formed on the surface of the second flexible carrier by coating manganese oxide slurry on the second flexible carrier.

34. A method for fabricating an energy storage apparatus in accordance with claim 32, wherein the cathode material is dip-coated or blade-coated on the surface of the second flexible carrier.

35. A method for fabricating an energy storage apparatus in accordance with claim 29, further comprising the steps of:
filling the encapsulation with the anode, the cathode and the electrolyte; and
sealing the encapsulation.

36. A method for fabricating an energy storage apparatus in accordance with claim 29, further comprising the step of combining the anode, the electrolyte and the cathode to form a multi-layer stack, wherein the first flexible carrier and the second flexible carrier form at least a part of the encapsulation.

37. An energy storage apparatus comprising a pair of electrodes including an anode and a cathode; and an electrolyte sandwiched between the pair of electrodes; wherein the electrolyte the electrolyte includes a hierarchical polymer structure.

38. An energy storage apparatus in accordance with claim 37, wherein the electrodes and the electrolyte are in a solid state.

39. An energy storage apparatus in accordance with claim 37, wherein the electrodes and the electrolyte are mechanically flexible.

40. An energy storage apparatus in accordance with claim 37, wherein the electrolyte includes a gelatin material.

41. An energy storage apparatus in accordance with claim 40, wherein the gelatin material is grafted with polyacrylamide.

42. An energy storage apparatus in accordance with claim 40, wherein the gelatin material is filled in a polyacrylonitrile fiber membrane.
